(19) United States
(12) Patent Application Publication
(10) Pub. No.: US 2026/0286228 A1
(43) Pub. Date: Sep. 24, 2026

(54) FLUID COKING FOR PROPPANT MATERIAL PRODUCTION

(71) Applicant: EXXONMOBIL TECHNOLOGY AND ENGINEERING COMPANY, Spring, TX (US)

(72) Inventors: Fritz A. BERNATZ, Spring, TX (US); Daniel G. RASMUSSEN, Alberta (CA); Jonathan M. GIESEKE, Pinehurst, TX (US)

(73) Assignee: EXXONMOBIL TECHNOLOGY AND ENGINEERING COMPANY, Spring, TX (US)

(21) Appl. No.: 19/473,769

(22) PCT Filed: Apr. 12, 2024
(86) PCT No.: PCT/US2024/024368

§ 371 Date: Oct. 8, 2025

Related U.S. Application Data
(60) Provisional application No. 63/496,307, filed on Apr. 14, 2023.

(51) Int. Cl. C10B 55/10; C09K 8/80; C10G 9/36

(52) U.S. Cl. CPC C10B 55/10; C09K 8/80; C10G 9/36; C10G 2300/807

(57) ABSTRACT

A fluid coker reactor for producing coke suitable for use as proppant. Methods for producing said coke include: reacting a heavy oil feedstock in the coking zone of a fluid coker reactor to form a vapor phase and hot coke; stripping at least a portion of hydrocarbons that adhere to the hot coke in a stripping zone located in a lower portion of the fluid coker reactor; scrubbing the vapor phase from the fluid coker reactor in a scrubber; heating the hot coke in a heater, wherein the heater produces a coke product; recycling a portion of the hot coke from the heater to the coking zone of the fluid coker reactor; removing a recycle portion from the coke product; and recycling a recycle feed including the recycle portion to a feed line fluidly connected to the fluid coker reactor.

### FIELD OF INVENTION

The present disclosure relates to a fluid coking process, and, more particularly, to a fluid coking process for producing proppant material.

### BACKGROUND

Heavy hydrocarbonaceous materials can be converted to more valuable products by various thermal processes including visbreaking, delayed coking, and fluid coking.

In fluid coking, a heavy oil chargestock, such as a vacuum residuum, is fed to a reactor that has therein a coking zone containing a fluidized bed of hot solid particles, usually coke particles, sometimes referred to as seed coke. The heavy oil undergoes thermal cracking at the high temperatures in the coking zone resulting in conversion products which include a cracked vapor fraction and solid coke. The solid coke is deposited on the surface of the seed coke particles and a portion of the coked-seed particles is sent from the coking zone to a heater, which is maintained at a temperature higher than that of the coking zone. Some of the coke is burned off in the heater and hot coke particles from the heater are returned to the coking zone as regenerated seed particles, typically serving as the primary heat source for the coking zone.

In some variants of the fluid coking process known as FLEXICOKING™ (developed by Exxon Research and Engineering), a portion of hot coke from the heater is circulated back and forth to a gasifier which is maintained at a temperature greater than that of the heater. In the gasifier, substantially all of the remaining coke on the coked seed particles is burned, or gasified, in the presence of oxygen (air) and steam to generate low heating value fuel gas which can be partly passed to the burner/heater to increase temperature in that zone and/or used as refinery fuel. Fluid coking processes, with or without an integrated gasification zone, are described, for instance in U.S. Pat. Nos. 3,726,791; 4,203,759; 4,213,848; and 4,269,696.

Coke, and in particular coke produced using fluid coking, has found many applications including in hydraulic fracturing and enhanced oil recovery operations. In fracturing applications, in particular for use as a proppant, coke must be granular in form and preferably should have a particle size in the range of about 10 mesh to about 200 mesh on the U.S. Sieve Series Scale. The particulate coke exhibits properties which makes it ideally suited for the contemplated fracturing service. For example, particulate coke can have a specific gravity in the range of 0.9 to 1.3 making said particulates easily suspendable in carrier fluids. Particulate coke is also a friable material so that, at high closure stresses, the particles crush and disintegrate into tiny fragments. The fragments which become entrained in the produced fluids can readily flow through the interstices of the packed fracture without bridging or plugging. The produced fragments are nonabrasive and therefore should not damage subsurface or surface equipment.

### SUMMARY OF INVENTION

A nonlimiting method of the present disclosure includes: providing a fluid coker reactor, wherein the fluid coker reactor has a coking zone in an upper portion of the fluid coker reactor, wherein the fluid coker reactor contains a fluidized bed of solid particles into which a heavy oil feedstock is introduced, wherein the fluid coker reactor is fluidly connected to an attrition steam line supplying attrition steam; reacting the heavy oil feedstock in the coking zone of the fluid coker reactor to form a vapor phase and hot coke; stripping at least a portion of hydrocarbons that adhere to the hot coke in a stripping zone located in a lower portion of the fluid coker reactor; scrubbing the vapor phase from the fluid coker reactor in a scrubber; heating the hot coke in a heater, wherein the heater receives the hot coke from the fluid coker reactor, and wherein the heater produces a coke product; recycling a portion of the hot coke from the heater to the coking zone of the fluid coker reactor via a heater return line; removing a recycle portion from the coke product; and recycling a recycle feed comprising the recycle portion to a feed line fluidly connected to the fluid coker reactor.

Another nonlimiting method of the present disclosure includes: providing a fluid coker reactor, wherein the fluid coker reactor has a coking zone in an upper portion of the fluid coker reactor, wherein the fluid coker reactor contains a fluidized bed of solid particles into which a heavy oil feedstock is introduced, wherein the fluid coker reactor is fluidly connected to an attrition steam line supplying attrition steam; reacting the heavy oil feedstock in the coking zone of the fluid coker reactor to form a vapor phase and hot coke; stripping at least a portion of hydrocarbons that adhere to the hot coke in a stripping zone located in a lower portion of the fluid coker reactor; scrubbing the vapor phase from the fluid coker reactor in a scrubber; heating the hot coke in a heater, wherein the heater receives the hot coke from the fluid coker reactor, and wherein the heater produces a coke product; recycling a portion of the hot coke from the heater to the coking zone of the fluid coker reactor via a heater return line; removing a recycle portion from the coke product; grinding the recycle portion of the coke product in a coke grinding system to produce fine particles; slurrifying the fine particles in a slurry mixer, wherein slurrifying comprises mixing the fine particles with a raw petroleum resid feed to form a slurry; and providing the slurry to a feed line of the fluid coker reactor.

A nonlimiting system of the present disclosure includes: a fluid coker reactor, wherein the fluid coker reactor contains a fluidized bed of solid particles, and wherein the fluid coker reactor is fluidly connected to an attrition steam line supplying attrition steam; a coking zone, wherein the coking zone is located in an upper portion of the fluid coker reactor, and wherein the coking zone is configured to react a heavy oil feedstock to form a vapor phase and hot coke; a stripping zone, wherein the stripping zone is located in a lower portion of the fluid coker reactor, and wherein the stripping zone is configured to strip at least a portion of hydrocarbons that adhere to the hot coke; a scrubber, wherein the scrubber scrubs the vapor phase from the fluid coker reactor; a heater, wherein the heater heats the hot coke from the fluid coker reactor, and wherein the heater produces a coke product; a heater return line, wherein the heater return line recycles a portion of the hot coke from the heater to the coking zone of the fluid coker reactor; and a recycle portion of the coke product, wherein the recycle portion is removed from the coke product, and wherein the recycle portion is recycled to a feed line fluidly connected to the fluid coker reactor.

These and other features and attributes of the disclosed methods and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 illustrates a nonlimiting example fluid coking system of the present disclosure.

FIG. 2 illustrates a nonlimiting example fines recycling system of the present disclosure.

### DETAILED DESCRIPTION

The present disclosure relates to a fluid coking process, and, more particularly, to a fluid coking process for producing proppant material.

Coke, and in particular fluid coke, can serve as an effective proppant for fracturing given properties such as density, strength, conductivity, and shape. Typically, the desired particle size range for fluid coke as a proppant is from 10 mesh to 200 mesh, or preferably from 70 mesh to 140 mesh. With traditional processing, a significant quantity of fluid coke may not be of appropriate or preferred size for use as proppant particulates.

The present disclosure provides a system and method of fluid coking including a control process and a fines recycling system, allowing for an increase in the yield of fluid coke that is in the preferred 70 mesh to 140 mesh range. This increase in yield allows for more efficient production, thus reducing costs. Additionally, increase in yield allows for a greater quantity of coke to be of usable value and thus be sequestered underground instead of being burned for fuel, potentially reducing carbon emissions.

### Systems and Methods

The present disclosure includes fluid coking system comprising, inter alia, a reactor, a heater, and a fines recycling system, all fluidly connected.

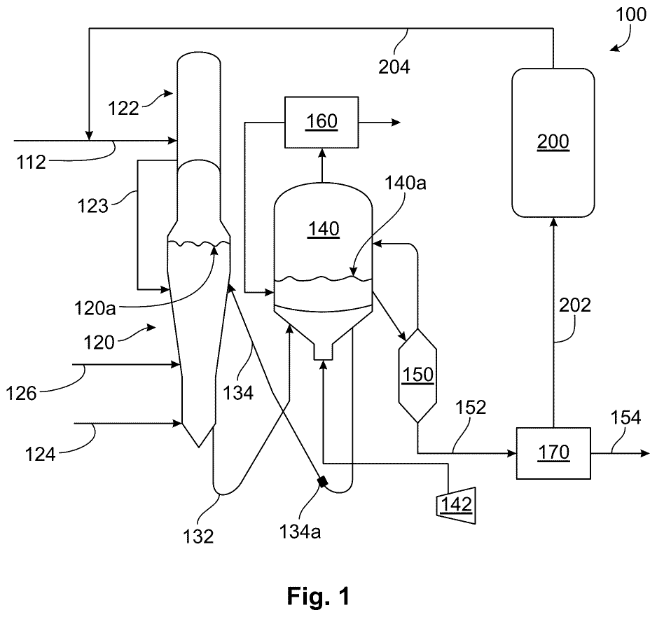

A nonlimiting example fluid coking system according to the present disclosure is shown in FIG. 1. Fluid coking system 100 continues reference to U.S. Pat. Nos. 9,670,417 and 5,176,819, which are incorporated herein by reference. In system 100, a heavy oil feed stream is passed via feed line 112 to the scrubber 122 and subsequently to the connected reactor 120. The reactor 120 contains a fluidized bed of hot seed particles (typically coke particles, as described below) having an upper level indicated at 120a.

It should be noted that there may be additional feed lines connected to the reactor 120 and/or the scrubber 122 in any combination. The additional feed lines may be connected to fresh feed, a recycle feed (as further described below), or any combination thereof.

A stripping zone (a lower portion of the reactor 120) has the purpose of removing adhered hydrocarbons from the coke. A fluidizing stripping gas (e.g., steam) is admitted at the base of the reactor 120 through stripping gas line 124, into the reactor 120 to produce a superficial fluidizing gas velocity in the seed particles. The velocity is typically in the range from 0.15 m/sec to 1.5 m/sec.

A major portion of the feed, undergoes thermal cracking reactions in a coking zone (an upper portion of the reactor 120) in the presence of the hot seed particles to form a vapor phase comprising cracked hydrocarbon and a coke layer containing adhered hydrocarbons on the fluidized seed particles. The vapor phase passes into a scrubber 122 mounted on the top of the coking reactor 120. A stream of heavy materials condensed in the scrubber 122 may be recycled to the coking reactor 120 as shown via line(s) 123 and/or may be conveyed for further use elsewhere. Coker conversion products are removed from the scrubber 122 for fractionation and product recovery in the conventional manner.

Additionally, an attrition steam line 126 comprising steam may be supplied to the reactor 120 above the stripping gas line 124, in order to provide additional control of the mean particle size of the circulating coke. The attrition steam is supplied via high velocity nozzles in the reactor vessel to fragment and abrade particles in order to control particle size.

The coke from the reactor 120 is carried via line 132 to the heater 140 (also referred to as the burner) where the coke is introduced into the fluidized bed of hot seed/coke particles in the heater 140 up to an upper level indicated at 140a. In the heater 140, combustion of the coked particles takes place to generate heat required for the endothermic cracking reactions taking place in the reactor 120. The heater 140 may have fluidly connected an air blower 142 which may blow air (e.g., heated air) to the heater 140 to support combustion of materials within the heater 140. The portion of the stripped coke that is not burned in order to satisfy the heat requirements of the coking zone is recycled from the heater 140 to the coking zone of the reactor 120 through heater return line 134 to supply heat to support the endothermic cracking reactions. Normally, the recycled coke passes out of heater return line 134 from the heater 140 to enter the reactor 120 near the top of the coking zone, as similarly shown in U.S. Pat. App. Pub. No. 2011/0206563 (which is incorporated herein by reference), with an inverted cap over the top of the return line to direct the recycled coke particles downwards into the coking zone. The cap on the top of the heater return line 134 may comprise an annular ring supported over the open top of the return line with a flat circular cap plate axially centered over the line and the annular ring, supported by a spider structure supporting the annular ring. In some embodiments, a smaller flow of hot coke from the heater 140 may flow via a second return line and enter higher up in the reactor 120 than heater return line 134 in order to minimize coking of portions of the reactor (e.g., reactor cyclones, if present) and thus minimize the associated increase in the pressure drop. Reference is made to U.S. Pat. App. Pub. No. 2011/0206563 for a description of these options.

The heater 140 is maintained at a temperature above the temperature maintained in the coking zone, for example, at a temperature from 40° C. to 200° C. above the operating temperature of the coking zone, preferably from by 65° C. to 175° C. above, and more preferably from 65° C. to 125° C. above. The heated solids are sent to the coking zone in an amount sufficient to maintain the coking temperature in the range of 450° C. to 650° C. The pressure in the coking zone is typically maintained in the range of 0 bar gauge (barg) to 10 barg, preferably in the range of 0.3 barg to 3 barg.

In some embodiments, a portion of the hot seed/coke from the heater 140 may be passed into the bottom of the stripping zone of reactor 120, allowing the temperature of the stripping zone to be controlled independently of the temperature of the coking zone so as to raise the temperature of the stripping zone above the temperature of the coking zone to achieve higher liquid yields. Besides improving fluidization in the stripping zone, the increase in the stripping zone temperature also may improve stripping of the occluded hydrocarbons to increase liquid yield and reduces fouling although the increase in the temperature of the stripping zone has, in the past, resulted in increases in the temperature of the reaction or coking zone which tend to reduce liquid yield as a result of overcracking. The interposition of the annular baffles above the stripping zone, however, reduces the recirculation of hot coke from the heater 140 into the reaction zone via the stripping zone, thus decoupling the stripping zone from the reaction zone. It should be noted that although discharge of the recycled hot coke from the heater 140 into the stripping zone of the reactor 120 is preferably made on the central axis of the reactor 120, different off-center locations may be selected if flow patterns at the bottom of the coking zone and in the stripper favor.

It should be noted that heater return line 134 may have a sampling point 134a where a sample of hot coke may be taken for control purposes, as described in relation to methods of the present disclosure below.

The gaseous effluent of the heater 140, including entrained solids, may optionally, in some embodiments, be passed through a cyclone system 160 (e.g., a primary cyclone and a secondary cyclone) in which the separation of the larger entrained solids may occur. The separated larger solids may be returned to the heater bed. The heated gaseous effluent which contains entrained solids may be removed from the heater 140.

A solid portion of hot coke may be removed from heater 140 and passed to an elutriator 150. The elutriator 150 may serve to further purify the hot coke. A gaseous output from the elutriator 150, which may further contain some entrained solids, is removed overhead from the elutriator 150 and recycled into the heater 140. The temperature in the fluidized bed in the heater 140 may be partly maintained by passing gaseous output from the elutriator 150 into the heater 140 via a return line. In some embodiments, supplementary heat may additionally be supplied to the heater 140 by hot coke recirculating from the elutriator 150 through an additional return line.

In some embodiments, the elutriator 150 may comprise a gasifier in which a bed of fluidized coke particles is maintained. As previously described, this gasification comprises a portion of FLEXICOKING™. In the gasifier, hot coke may be converted to a fuel gas by partial combustion in the presence of steam in an oxygen-deficient atmosphere. The gasifier may be suitably maintained at a temperature above the temperature of the heater, for example, a temperature ranging from about 870° C. to 1100° C. The gasifier may be maintained at a suitable pressure, for example, at a pressure ranging from 0 barg to 10 barg, preferably at a pressure ranging from 1.5 barg to 3 barg. Steam, a molecular oxygen-containing gas such as air, commercial oxygen, or air enriched with oxygen may be supplied to a gasifier. The reaction of the coke particles in the gasifier with the steam and the oxygen-containing gas produces a hydrogen and carbon monoxide-containing fuel gas of low heating value, typically from 3 MJ/kg to 7 MJ/kg. While hot coke may also be recirculated to the heater from the gasifier (if present as in a FLEXICOKING™ unit), this will generally not be favored as the gasifier coke is at a lower temperature than heater coke as a result of the fuel gas conversion reactions taking place in the gasifier.

Coke product may be obtained via coke product line 152. It should be noted that coke product line 152 may be fluidly connected to the bottom of the elutriator 150 (if present) or in some embodiments may be directly connected to the heater 140.

The present disclosure may further include a fines recycle system 200. The fines recycle system 200 may receive a separated recycle portion of coke product from supply line 202 that is fluidly connected to coke product line 152. The recycle line 204 may supply a recycle feed from the fines recycle system 200 to the feed line 112 (and/or any additional feed lines of the reactor 120 and scrubber 122, if present). It should be noted that the coke product in coke product line 152 may pass through a separator 170 prior to being transferred to supply line 202. A separator 170 may remove from the coke product the particles that are outside the acceptable range (e.g., particles smaller than the acceptable range, larger than the acceptable range, or both) for proppant usage for reprocessing and/or recycling. The acceptable range may be from 50 mesh to 150 mesh, or preferably from 70 mesh to 140 mesh. In some embodiments, the separator 170 may divert to supply line 202 particles smaller than the acceptable range (e.g., smaller than 140 mesh). In some embodiments, the separator 170 may divert to supply line 202 particles larger than the acceptable range (e.g., larger than 70 mesh). In some embodiments, the separator 170 may divert to supply line 202 particles smaller than and larger than the acceptable range (e.g., all particles smaller than 140 mesh and all particles larger than 70 mesh). The separator 170 may comprise any suitable separator for particles known in the art including, but not limited to, a cyclone separator, a mesh sieve separator, the like, or any combination thereof. Following removal from the coke product, proppant-spec coke particles may flow through proppant-spec particle line 154 for distribution and use. Proppant-spec refers to particles generally within a proppant size range and thus suitable for use as a proppant. A majority of particles may be within the proppant size range for a product to be considered proppant-spec. A majority may include, by weight of particles, from 50 wt % to 98 wt %, or from 50 wt % to 90 wt %, or 60 wt % to 90 wt %, or 65 wt % to 90 wt %, or 70 wt % to 90 wt %, or 70 wt % to 80 wt %, or greater than 50 wt %, or greater than 65 wt %, or greater than 70 wt %, or greater than 75 wt %. The proppant size range may include from 50 mesh to 200 mesh, or 50 mesh to 140 mesh, or 70 mesh to 200 mesh, or 70 mesh to 140 mesh.

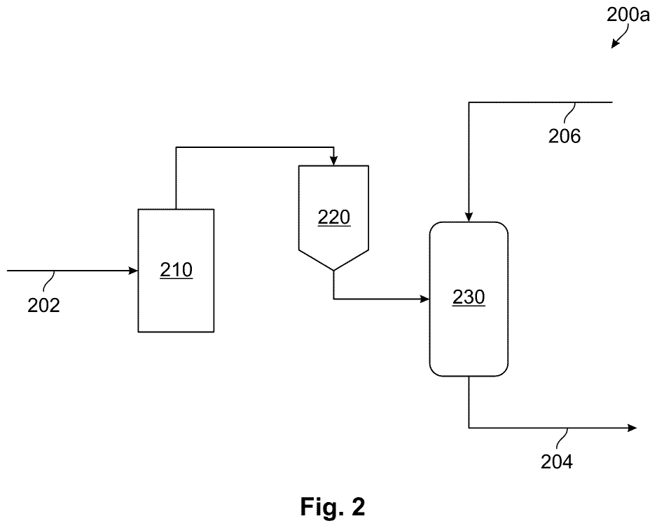

The fines recycle system 200 may preferably comprise a slurrification system; a nonlimiting example slurrification system 200a is shown in FIG. 2 (with continued reference to FIG. 1). Supply line 202 provides the recycle portion of coke product to coke grinding system 210. Coke grinding system 210 grinds coke particles larger than the acceptable size range for proppant into smaller fines (e.g., into particles with a size smaller than 70 mesh, or smaller than 100 mesh, or smaller than 140 mesh, or from 100 mesh to 400 mesh, or from 140 mesh to 400 mesh). It should be noted that in some embodiments supply line 202 may provide particles smaller than 140 mesh in addition to the aforementioned larger particles to be ground, such that the smaller particles, if present, can be included in the fines and be recycled. The ground fines may be transferred to a fines silo 220. The fines silo 220 may have a recovery cyclone or other similar equipment attached thereto. Fines from the fines silo 220 may subsequently fed to a slurry mixer 230. The slurry mixer 230 receives raw petroleum resid feed via resid feed line 206. The slurry mixer 230 may have an internal mixing system comprising an impeller capable of mixing the fines and the raw petroleum resid into a slurry comprising fine particles. The slurry comprising fine particles may then be recycled as recycle feed to the fluid coker reactor 120 via recycle line 204.

Creating coke fines by grinding coke product allows for increased precision of particle size for proppant production. The recycling of particles, in particular fine particles, is believed to, without being bound by theory, allow for coke particles to be reintroduced into the reactor 120 so that the particles may grow into the desired size range. This in turn allows for increased yield of on-spec proppant product.

The present disclosure may further comprise a method of producing coke proppant utilizing the system described above. Returning to FIG. 1, the method may include a control process wherein a sample of hot coke is taken from sampling point 134a. The sample is subsequently screened through a mesh screen. The mesh screen may be of a size from 70 mesh to 140 mesh (or preferably from 90 mesh to 110 mesh, or more preferably 100 mesh size). The weight percentage of material retained on the screen is recorded (referred to herein as the “sieve value”). Based on the sieve value, the flow of attrition steam through attrition steam line 126 may be adjusted. An increase in sieve value indicates a larger proportion of product coke particles within the desired proppant size range. A decrease in sieve value indicates a smaller proportion of product coke particles within the desired proppant size range. Thus, sieve value is proportional to the optimal attrition steam flow: an increase sieve value indicates attrition steam flow should be increased so as to reduce particle size, and a decreased sieve value indicates attrition steam flow should be decreased so as to increase particle size. The control process described herein may be executed at periodic intervals (e.g., every 24 hours, or every 8 hours, or preferably every 12 hours) and may be executed through manual or automated means. One skilled in the art should be able to, with the benefit of this disclosure, implement the above described control process in the fluid coking system described herein.

### Seed Material and Feedstock

Although the seed material in the reactor will normally be coke particles, the seed material may also be other refractory materials selected from the group consisting of silica, alumina, zirconia, magnesia, or mullite. The seed material may also be synthetically prepared, or naturally occurring materials, such as pumice, clay, kieselguhr, diatomaceous earth, bauxite. The seed particles preferably have an average particle size of about 40 to 1000 microns, preferably from about 40 to 400 microns.

Concerning coke feedstocks, any heavy hydrocarbonaceous oil which is typically fed to a fluid coking process can be used in the present disclosure. Generally, the heavy oil will have a Conradson Carbon Residue (ASTM D189-06[2019]) of about 5 wt % to 40 wt % and be comprised of fractions, the majority of which boil above about 500° C. and more usually above 540° C. or even higher (e.g., 590° C.). Suitable heavy oils include heavy petroleum crudes, reduced petroleum crudes, petroleum atmospheric distillation bottoms, petroleum vacuum distillation bottoms, pitch, asphalt, bitumen, liquid products derived from coal liquefaction processes, including coal liquefaction bottoms, and mixtures of these materials.

A typical petroleum chargestock suitable for coking in a fluid coking unit will have, for example, a composition and properties within the following ranges:

| | |
|---|---|
| Conradson Carbon | 5 wt % to 40 wt % |
| Sulfur | 1.5 wt % to 8 wt % |
| Hydrogen | 9 wt % to 11 wt % |
| Nitrogen | 0.2 wt % to 2 wt % |
| Carbon | 80 wt % to 86 wt % |
| Metals | 1 wppm to 2000 wppm |
| Boiling Point | 340° C.+-650° C.+ |
| API Gravity | −10° to 35° |

### Additional Embodiments

Embodiment 1. A method comprising: providing a fluid coker reactor, wherein the fluid coker reactor has a coking zone in an upper portion of the fluid coker reactor, wherein the fluid coker reactor contains a fluidized bed of solid particles into which a heavy oil feedstock is introduced, wherein the fluid coker reactor is fluidly connected to an attrition steam line supplying attrition steam; reacting the heavy oil feedstock in the coking zone of the fluid coker reactor to form a vapor phase and hot coke; stripping at least a portion of hydrocarbons that adhere to the hot coke in a stripping zone located in a lower portion of the fluid coker reactor; scrubbing the vapor phase from the fluid coker reactor in a scrubber; heating the hot coke in a heater, wherein the heater receives the hot coke from the fluid coker reactor, and wherein the heater produces a coke product; recycling a portion of the hot coke from the heater to the coking zone of the fluid coker reactor via a heater return line; removing a recycle portion from the coke product; and recycling a recycle feed comprising the recycle portion to a feed line fluidly connected to the fluid coker reactor.

Embodiment 2. The method of Embodiment 1, further comprising providing proppant-spec coke particles, wherein the proppant-spec coke particles comprise the coke product with the recycle portion removed therefrom, and wherein greater than 50 wt % of the proppant-spec coke particles have a size from 70 mesh to 140 mesh.

Embodiment 3. The method of Embodiments 1 or 2, wherein removing the recycle portion from the coke product comprises removing particles larger than a proppant size range, smaller than the proppant size range, or both, and wherein the proppant size range is from 70 mesh to 140 mesh.

Embodiment 4. The method of any one of Embodiments 1-3, wherein recycling the recycle feed comprising the recycle portion comprises passing the recycle portion through a fines recycling system.

Embodiment 5. The method of Embodiment 4, wherein passing the recycle portion of the coke product through the fines recycling system comprises: grinding the recycle portion of the coke product in a coke grinding system to produce fine particles; slurrifying the fine particles in a slurry mixer, wherein slurrifying comprises mixing the fine particles with a raw petroleum resid feed to form a slurry; and providing the slurry as the recycle feed to the feed line of the fluid coker reactor.

Embodiment 6. The method of any one of Embodiments 1-5, further comprising: obtaining a sample of the hot coke from a sampling point on the heater return line; screening the sample through a mesh screen, wherein the mesh screen has a sieve size from 70 mesh to 140 mesh; obtaining a sieve value, wherein the sieve value comprises a weight percentage of the sample retained on the mesh screen after sieving of the sample; and adjusting a flow of the attrition steam in the attrition steam line based on the sieve value.

Embodiment 7. The method of Embodiment 6, wherein the sieve size is about 100 mesh.

Embodiment 8. The method of any one of Embodiments 1-7, further comprising passing the coke product through an elutriator, wherein the elutriator further purifies the coke product, and wherein the elutriator returns a gaseous output to the heater.

Embodiment 9. The method of Embodiment 8, wherein passing the coke product through an elutriator comprises passing the coke product through a gasifier, wherein passing the coke product through the gasifier comprises converting a portion of the coke product to a fuel gas by partial combustion in the presence of steam in an oxygen-deficient atmosphere, and wherein the gaseous output comprises the fuel gas.

Embodiment 10. The method of any one of Embodiments 1-9, wherein heating the hot coke in a heater further comprises maintaining the heater at a heater temperature, wherein the heater temperature is from 40° C. to 200° C. above an operating temperature of the coking zone.

Embodiment 11. The method of any one of Embodiments 1-10, further comprising: blowing hot air from a hot air blower into the heater.

Embodiment 12. The method of any one of Embodiments 1-11, wherein the attrition steam line supplies attrition steam via high velocity nozzles so as to fragment coke particles of the hot coke in the fluid coker reactor.

Embodiment 13. A proppant product produced using the method of Embodiment 1.

Embodiment 14. The proppant product of Embodiment 13, wherein greater than 50 wt % of the proppant product has a size from 70 mesh to 140 mesh.

Embodiment 15. A method comprising: providing a fluid coker reactor, wherein the fluid coker reactor has a coking zone in an upper portion of the fluid coker reactor, wherein the fluid coker reactor contains a fluidized bed of solid particles into which a heavy oil feedstock is introduced, wherein the fluid coker reactor is fluidly connected to an attrition steam line supplying attrition steam; reacting the heavy oil feedstock in the coking zone of the fluid coker reactor to form a vapor phase and hot coke; stripping at least a portion of hydrocarbons that adhere to the hot coke in a stripping zone located in a lower portion of the fluid coker reactor; scrubbing the vapor phase from the fluid coker reactor in a scrubber; heating the hot coke in a heater, wherein the heater receives the hot coke from the fluid coker reactor, and wherein the heater produces a coke product; recycling a portion of the hot coke from the heater to the coking zone of the fluid coker reactor via a heater return line; removing a recycle portion from the coke product; grinding the recycle portion of the coke product in a coke grinding system to produce fine particles; slurrifying the fine particles in a slurry mixer, wherein slurrifying comprises mixing the fine particles with a raw petroleum resid feed to form a slurry; and providing the slurry to a feed line of the fluid coker reactor.

Embodiment 16. A system comprising: a fluid coker reactor, wherein the fluid coker reactor contains a fluidized bed of solid particles, and wherein the fluid coker reactor is fluidly connected to an attrition steam line supplying attrition steam; a coking zone, wherein the coking zone is located in an upper portion of the fluid coker reactor, and wherein coking zone is configured to react a heavy oil feedstock to form a vapor phase and hot coke; a stripping zone, wherein the stripping zone is located in a lower portion of the fluid coker reactor, and wherein the stripping zone is configured to strip at least a portion of hydrocarbons that adhere to the hot coke; a scrubber, wherein the scrubber scrubs the vapor phase from the fluid coker reactor; a heater, wherein the heater heats the hot coke from the fluid coker reactor, and wherein the heater produces a coke product; a heater return line, wherein the heater return line recycles a portion of the hot coke from the heater to the coking zone of the fluid coker reactor; and a recycle portion of the coke product, wherein the recycle portion is removed from the coke product, and wherein the recycle portion is recycled to a feed line fluidly connected to the fluid coker reactor.

Embodiment 17. The system of Embodiment 16, further comprising a proppant-spec particle line for conveying proppant-spec coke particles, wherein the proppant-spec coke particles comprise the coke product with the recycle portion removed therefrom, and wherein greater than 50 wt % of the proppant-spec coke particles have a size from 70 mesh to 140 mesh.

Embodiment 18. The system of Embodiments 16 or 17, wherein the recycle portion of the coke product comprises particles larger than a proppant size range, smaller than the proppant size range, or both, and wherein the proppant size range is from 70 mesh to 140 mesh.

Embodiment 19. The system of any one of Embodiments 16-18, further comprising a fines recycling system, wherein the fines recycle system processes the recycle portion prior the recycle portion entering the feed line.

Embodiment 20. The system of Embodiment 19, wherein the fines recycling system comprises: a coke grinding system, wherein the coke grinding system grinds the recycle portion to produce fine particles; and a slurry mixer, wherein the slurry mixer slurrifies the fine particles to a slurry by mixing the fine particles with a raw petroleum resid feed, and wherein the slurry is recycled to the feed line of the fluid coker reactor.

Embodiment 21. The system of any one of Embodiments 16-20, further comprising: a sampling point on the heater return line, wherein the sampling point provides a sample comprising hot coke; a mesh screen, wherein the mesh screen has a sieve size from 70 mesh to 140 mesh, and wherein the mesh screen is configured to screen the sample; and a sieve value, wherein the sieve value comprises a weight percentage of the sample retained on the mesh screen after sieving of the sample, and wherein the sieve value allows for adjusting of a flow of the attrition steam in the attrition steam line.

Embodiment 22. The system of Embodiment 21, wherein the sieve size is about 100 mesh.

Embodiment 23. The system of any one of Embodiments 16-22, further comprising an elutriator, wherein the elutriator further purifies the coke product, and wherein the elutriator returns a gaseous output to the heater.

Embodiment 24. The system of Embodiment 23, wherein the elutriator comprises a gasifier, wherein the gasifier converts a portion of the coke product to a fuel gas by partial combustion in the presence of steam in an oxygen-deficient atmosphere, and wherein the gaseous output comprises the fuel gas.

Embodiment 25. The system of any one of Embodiments 16-24, wherein the heater has a heater temperature, wherein the heater temperature is from 40° C. to 200° C. above an operating temperature of the coking zone.

Embodiment 26. The system of any one of Embodiments 16-25, further comprising: a hot air blower, wherein the hot air blower blows hot air into the heater.

Embodiment 27. The system of any one of Embodiments 16-26, wherein the attrition steam line supplies attrition steam via high velocity nozzles so as to fragment coke particles of the hot coke in the fluid coker reactor.

Embodiment 28. A proppant product produced using the system of Embodiment 16.

Embodiment 29. The proppant product of Embodiment 28, wherein greater than 50 wt % of the proppant product has a size from 70 mesh to 140 mesh.

Therefore, the present invention is well adapted to attain the ends and advantages mentioned as well as those that are inherent therein. The particular examples and configurations disclosed above are illustrative only, as the present invention may be modified and practiced in different, but equivalent, manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

1.-15.

16. A method comprising:
providing a fluid coker reactor, wherein the fluid coker reactor has a coking zone in an upper portion of the fluid coker reactor, wherein the fluid coker reactor contains a fluidized bed of solid particles into which a heavy oil feedstock is introduced, wherein the fluid coker reactor is fluidly connected to an attrition steam line supplying attrition steam;
reacting the heavy oil feedstock in the coking zone of the fluid coker reactor to form a vapor phase and hot coke;
stripping at least a portion of hydrocarbons that adhere to the hot coke in a stripping zone located in a lower portion of the fluid coker reactor;
scrubbing the vapor phase from the fluid coker reactor in a scrubber;
heating the hot coke in a heater, wherein the heater receives the hot coke from the fluid coker reactor, and wherein the heater produces a coke product;
recycling a portion of the hot coke from the heater to the coking zone of the fluid coker reactor via a heater return line;
removing a recycle portion from the coke product; and
recycling a recycle feed comprising the recycle portion to a feed line fluidly connected to the fluid coker reactor.

17. The method of claim 16, further comprising providing proppant-spec coke particles, wherein the proppant-spec coke particles comprise the coke product with the recycle portion removed therefrom, and wherein greater than 50 wt % of the proppant-spec coke particles have a size from 70 mesh to 140 mesh.

18. The method of claim 16, wherein removing the recycle portion from the coke product comprises removing particles larger than a proppant size range, smaller than the proppant size range, or both, and wherein the proppant size range is from 70 mesh to 140 mesh.

19. The method of claim 16, wherein recycling the recycle feed comprising the recycle portion comprises passing the recycle portion through a fines recycling system.

20. The method of claim 19, wherein passing the recycle portion of the coke product through the fines recycling system comprises:
grinding the recycle portion of the coke product in a coke grinding system to produce fine particles;
slurrifying the fine particles in a slurry mixer, wherein slurrifying comprises mixing the fine particles with a raw petroleum resid feed to form a slurry; and
providing the slurry as the recycle feed to the feed line of the fluid coker reactor.

21. The method of claim 16, further comprising:
obtaining a sample of the hot coke from a sampling point on the heater return line;
screening the sample through a mesh screen, wherein the mesh screen has a sieve size from 70 mesh to 140 mesh;
obtaining a sieve value, wherein the sieve value comprises a weight percentage of the sample retained on the mesh screen after sieving of the sample; and
adjusting a flow of the attrition steam in the attrition steam line based on the sieve value.

22. The method of claim 16, further comprising passing the coke product through an elutriator, wherein the elutriator further purifies the coke product, and wherein the elutriator returns a gaseous output to the heater.

23. The method of claim 22, wherein passing the coke product through an elutriator comprises passing the coke product through a gasifier, wherein passing the coke product through the gasifier comprises converting a portion of the coke product to a fuel gas by partial combustion in the presence of steam in an oxygen-deficient atmosphere, and wherein the gaseous output comprises the fuel gas.

24. The method of claim 16, wherein heating the hot coke in a heater further comprises maintaining the heater at a heater temperature, wherein the heater temperature is from 40° C. to 200° C. above an operating temperature of the coking zone.

25. The method of claim 16, wherein the attrition steam line supplies attrition steam via high velocity nozzles so as to fragment coke particles of the hot coke in the fluid coker reactor.

26. A proppant product produced using the method of claim 16.

27. The proppant product of claim 26, wherein greater than 50 wt % of the proppant product has a size from 70 mesh to 140 mesh.

28. A method comprising:
providing a fluid coker reactor, wherein the fluid coker reactor has a coking zone in an upper portion of the fluid coker reactor, wherein the fluid coker reactor contains a fluidized bed of solid particles into which a heavy oil feedstock is introduced, wherein the fluid coker reactor is fluidly connected to an attrition steam line supplying attrition steam;
reacting the heavy oil feedstock in the coking zone of the fluid coker reactor to form a vapor phase and hot coke;
stripping at least a portion of hydrocarbons that adhere to the hot coke in a stripping zone located in a lower portion of the fluid coker reactor;
scrubbing the vapor phase from the fluid coker reactor in a scrubber;
heating the hot coke in a heater, wherein the heater receives the hot coke from the fluid coker reactor, and wherein the heater produces a coke product;
recycling a portion of the hot coke from the heater to the coking zone of the fluid coker reactor via a heater return line;
removing a recycle portion from the coke product;
grinding the recycle portion of the coke product in a coke grinding system to produce fine particles;
slurrifying the fine particles in a slurry mixer, wherein slurrifying comprises mixing the fine particles with a raw petroleum resid feed to form a slurry; and
providing the slurry to a feed line of the fluid coker reactor.

29. A system comprising:
a fluid coker reactor, wherein the fluid coker reactor contains a fluidized bed of solid particles, and wherein the fluid coker reactor is fluidly connected to an attrition steam line supplying attrition steam;
a coking zone, wherein the coking zone is located in an upper portion of the fluid coker reactor, and wherein coking zone is configured to react a heavy oil feedstock to form a vapor phase and hot coke;
a stripping zone, wherein the stripping zone is located in a lower portion of the fluid coker reactor, and wherein the stripping zone is configured to strip at least a portion of hydrocarbons that adhere to the hot coke;
a scrubber, wherein the scrubber scrubs the vapor phase from the fluid coker reactor;
a heater, wherein the heater heats the hot coke from the fluid coker reactor, and wherein the heater produces a coke product;
a heater return line, wherein the heater return line recycles a portion of the hot coke from the heater to the coking zone of the fluid coker reactor; and
a recycle portion of the coke product, wherein the recycle portion is removed from the coke product, and wherein the recycle portion is recycled to a feed line fluidly connected to the fluid coker reactor.

30. The system of claim 29, further comprising a proppant-spec particle line for conveying proppant-spec coke particles, wherein the proppant-spec coke particles comprise the coke product with the recycle portion removed therefrom, and wherein greater than 50 wt % of the proppant-spec coke particles have a size from 70 mesh to 140 mesh.

31. The system of claim 30, further comprising a fines recycling system, wherein the fines recycle system processes the recycle portion prior the recycle portion entering the feed line.

32. The system of claim 29, wherein the fines recycling system comprises:
a coke grinding system, wherein the coke grinding system grinds the recycle portion to produce fine particles; and
a slurry mixer, wherein the slurry mixer slurrifies the fine particles to a slurry by mixing the fine particles with a raw petroleum resid feed, and wherein the slurry is recycled to the feed line of the fluid coker reactor.

33. The system of claim 29, further comprising:
a sampling point on the heater return line, wherein the sampling point provides a sample comprising hot coke;
a mesh screen, wherein the mesh screen has a sieve size from 70 mesh to 140 mesh, and wherein the mesh screen is configured to screen the sample; and
a sieve value, wherein the sieve value comprises a weight percentage of the sample retained on the mesh screen after sieving of the sample, and wherein the sieve value allows for adjusting of a flow of the attrition steam in the attrition steam line.

34. The system of claim 29, further comprising an elutriator, wherein the elutriator further purifies the coke product, and wherein the elutriator returns a gaseous output to the heater.

35. The system of claim 34, wherein the elutriator comprises a gasifier, wherein the gasifier converts a portion of the coke product to a fuel gas by partial combustion in the presence of steam in an oxygen-deficient atmosphere, and wherein the gaseous output comprises the fuel gas.
